(19) United States
(12) Patent Application Publication
(10) Pub. No.: US 2014/0370823 A1
(43) Pub. Date: Dec. 18, 2014

(54) Methods, processing device, computer programs, computer program products, and antenna apparatus for calibration of antenna apparatus

(71) Applicant: Shaowei Yu, Beijing (CN)

(72) Inventor: Shaowei Yu, Beijing (CN)

(73) Assignee: Optis Cellular Technology, LLC, Plano, TX (US)

(21) Appl. No.: 14/353,259

(22) PCT Filed: Oct. 21, 2011
(86) PCT No.: PCT/CN2011/001748

§ 371 Date: Sep. 3, 2014

(51) Int. Cl. H04B 1/40; H04B 17/00

(52) U.S. Cl. CPC H04B 1/401; H04B 17/0062; H04B 17/0007
USPC 455/73

(57) ABSTRACT

The invention relates to a method 20 in an antenna array system 15 for calibration of an antenna apparatus 1. The method 20 comprises: estimating 21 coarse receive delays for the receive chains 5₁, . . . , 5ₙ and coarse transmit delays for the transmit chains 6₁, . . . , 6ₙ; adjusting 22 a timing of the receive chains 5₁, . . . , 5ₙ based on the estimated coarse receive delays so that the receive chains 5₁, . . . , 5ₙ align with the maximum coarse receive delay difference and adjusting a timing of the transmit chains 6₁, . . . , 6ₙ based on the estimated coarse transmit delays so that the transmit chains 6₁, . . . , 6ₙ align with the maximum coarse transmit delay difference; estimating 23 a fine delay and initial phase for the receive chains 5₁, . . . , 5ₙ and the transmit chains 6₁, . . . , 6ₙ based on their phase-frequency characteristics; adjusting 24 an intermediate frequency timing of the antenna apparatus 1 based on the estimated fine delay; compensating 25 initial phase and residual delay at base band frequency-domain signal; estimating 26 amplitude-frequency characteristics of the transceiver chains 4₁, . . . , 4ₙ; and compensating 27 the estimated amplitude-frequency characteristics at base band frequency-domain signal.

### TECHNICAL FIELD

The technology disclosed herein relates generally to the field of antenna technology of wireless communication systems, and in particular to antenna calibration within such communication systems.

### BACKGROUND OF THE INVENTION

Multiple antennas technology is widely adopted in wireless communication for providing higher data rates and larger coverage, e.g. in Time Division Synchronous Code Division Multiple Access (TD-SCDMA), Time Division Long Term Evolution (TD-LTE) and near future LTE-advanced system. In multiple antennas array, a plurality of antennas are spatially arranged and their respective transceivers are electrically connected via a feed network so as to cooperatively transmit and/or receive Radio Frequency (RF) signals using beam-forming or pre-coding techniques. The adaptive beam-forming is able to automatically optimize the radiation beam pattern of the antennas array to achieve high gain and controlled beam-width in desired directions by adjusting the elemental control weights in terms of spatial channel correlation. This minimizes transmission and reception power of RF signals in other directions than the desired and maximizes the targeted user received Signal to Interference-plus-Noise Ratio (SINR) and minimizes the interference on the non-targeted users. Inter-cell and intra-cell co-channel interference is thus suppressed and the throughput at the edge of cell and the system capacity is greatly improved.

The eNodeB's received/transmitted signal from/to the air-interface must come through the array antenna's transceiver apparatus chains. The beam-forming's weights are generated based on the compound spatial channel characteristic which combines the spatial wireless channel and antenna apparatus chain's channel. So, the accuracy of the antenna array's beam-forming characteristics typically depends on the accuracy of the knowledge of the characteristic of the antenna's transceiver apparatus chains. A purpose of antenna calibration is to minimize amplitude and phase differences among antenna's transceiver apparatus chains.

Since the antenna's transceiver apparatus chains always consist of different Intermediate Frequency (IF) and RF process elements, they often experience different amplitude degradation and phase shift. Further, the antenna elements, feeder cable and RF circuitry composed of analog electronic components also often suffer from different amplitude attenuation and phase shift with temperature, humidity and device aging. Moreover, the bandwidth of ongoing LTE-Advanced (LTE-A) is significantly wider than ones in previous wireless standards including LTE. The scalable system bandwidth in LTE-Advanced system can exceed 20 MHz, and potentially up to contiguous or non-contiguous 100 MHz. This makes it more difficult to ensure that the overall channel response of the RF chains of the eNodeB are close to ideal and thus introduces significant variations over frequency of the effective channel over the entire bandwidth.

If not properly dealt with it, the system may have to cope with a substantial increase of frequency-selectivity, which may have serious implications on channel estimation quality as well as the performance of beam-forming or pre-coding.

The real-time antenna calibration is done to remove the difference on amplitude and phase among antennas chains to keep more precise beam pattern and pre-coding.

The common delay for all antennas chains introduced by cable length can be detected and calibrated by Common Public Radio Interface (CPRI). However, the amplitude and phase difference among the antennas apparatus chains cannot be detected easily. Several antenna calibration methods have been proposed.

One kind of real-time antenna calibration, which is widely applied in TD-SCDMA or SCDMA systems, constructs the circular shift calibration sequences for different calibration antenna, which is derived from one basic sequence with good auto-correlation. The delay compensation is done in time domain, a high over-sampling over the normal transmit signals is usually asked to fit for the fractional delay compensation whose delay is less than a sampling duration. However, such solution is hard to implement in a wideband system.

In another kind of real-time antenna calibration, the sub-carriers of OFDM system are divided into groups and each group has its transmitted calibration pilot signal. The calibration compensation coefficient for different antenna is made in terms of the grouped sub-carriers frequency domain channel response estimation. However, in such solution, the estimation accuracy is highly limited.

Tiny delay difference among antennas will show larger phase shift with higher sub-carrier frequency in Orthogonal Frequency Division Multiplexing (OFDM) systems. In field tests, the error of beam-forming pattern is often limited to less than 5 degrees by telecommunication operator. In other words, the delay difference among antenna elements must be less than 132 Ts (sampling duration) for 20M TD-LTE system.

All the above antenna calibration approaches often fail to the strict calibration accuracy and complexity on the phase and amplitude of the array antennas, particularly if applied to wideband systems.

### SUMMARY OF THE INVENTION

An object of the present invention is to solve or at least mitigate the above mentioned problem.

The object is according to a first aspect of the invention achieved by a method in an antenna array system for calibration of an antenna apparatus. The antenna apparatus comprises an antenna array and two or more transceiver chains. Each transceiver chain comprises a receive chain and a transmit chain and an antenna element. One transceiver chain of the at least two transceiver chains further comprises an antenna calibration control unit and a reference calibration antenna, wherein the antenna calibration control unit is arranged to switch the transceiver chain between a calibration mode and a operation mode. The method comprises: estimating coarse receive delays for the receive chains and coarse transmit delays for the transmit chains; adjusting a timing of the receive chains based on the estimated coarse receive delays so that the receive chains align with the maximum coarse receive delay difference, and adjusting a timing of the transmit chains based on the estimated coarse transmit delays so that the transmit chains align with the maximum coarse transmit delay difference; estimating a fine delay and initial phase for the receive chains and the transmit chains based on their phase-frequency characteristics; adjusting an intermediate frequency timing of the antenna apparatus based on the estimated fine delay; compensating initial phase and residual delay at base band frequency-domain signal; estimating amplitude-frequency characteristics of the transceiver chains; and compensating the estimated amplitude-frequency characteristics at base band frequency-domain signal.

The method provides an improved antenna calibration, and in particular improved real-time antenna calibration, wherein the antenna calibration accuracy is improved and the calculation complexity is efficiently decreased. The transmit and receive paths for the antenna can be calibrated without interruption of normal service. Further, as one of the transceiver chains is re-used for calibration purposes, i.e. by not having a dedicated transceiver chain used only for calibration purposes, the number of hardware components can be reduced. The method supports sub-bands calibration for a wideband system simultaneously. Further, the group delays for all sub-bands may be detected jointly. The method may be implemented with less processor load and improved calibration performance. Transmit and receive calibration may be finished in one half-frame, respectively.

The object is according to a second aspect of the invention achieved by processing device for calibration of an antenna apparatus. The antenna apparatus comprises an antenna array and two or more transceiver chains. Each transceiver chain comprises a receive chain and a transmit chain and an antenna element. One transceiver chain of the at least two transceiver chains further comprises an antenna calibration control unit and a reference calibration antenna, wherein the antenna calibration control unit is arranged to switch the transceiver chain between a calibration mode and a operation mode. The processing device is arranged to: estimate, by means of a coarse receive delay unit and a coarse transmit delay unit, a coarse receive delays for the receive chains and coarse transmit delays for the transmit chains, respectively; adjust, by a first timing unit, a timing of the receive chains based on the estimated coarse receive delays so that the receive chains align with the maximum coarse receive delay difference and adjusting a timing of the transmit chains based on the estimated coarse transmit delays so that the transmit chains align with the maximum coarse transmit delay difference; estimate, by a fine delay and initial phase unit, a fine delay and initial phase for the receive chains and the transmit chains based on their phase-frequency characteristics; adjust, by a second timing unit, an intermediate frequency timing of the antenna apparatus based on the estimated fine delay; compensate, by a first compensating unit, initial phase and residual delay at base band frequency-domain signal; estimate, by an estimation unit, amplitude-frequency characteristics of the transceiver chains; and compensate, by a second compensating unit, the estimated amplitude-frequency characteristics at base band frequency-domain signal.

The object is according to a third aspect of the invention achieved by computer program for a processing device for calibration of an antenna apparatus. The antenna apparatus comprises an antenna array and two or more transceiver chains. Each transceiver chain comprises a receive chain and a transmit chain and an antenna element. One transceiver chain of the at least two transceiver chains further comprises an antenna calibration control unit and a reference calibration antenna, wherein the antenna calibration control unit is arranged to switch the transceiver chain between a calibration mode and a operation mode. The computer program comprises computer program code, which, when run on the processing device, causes the processing device to perform the steps of: estimating coarse receive delays for the receive chains and coarse transmit delays for the transmit chains; adjusting a timing of the receive chains based on the estimated coarse receive delays so that the receive chains align with the maximum coarse receive delay difference and adjusting a timing of the transmit chains based on the estimated coarse transmit delays so that the transmit chains align with the maximum coarse transmit delay difference; estimating a fine delay and initial phase for the receive chains and the transmit chains based on their phase-frequency characteristics; adjusting an intermediate frequency timing of the antenna apparatus based on the estimated fine delay; compensating initial phase and residual delay at base band frequency-domain signal; estimating amplitude-frequency characteristics of the transceiver chains; and compensating the estimated amplitude-frequency characteristics at base band frequency-domain signal.

The object is according to a fourth aspect of the invention achieved by computer program product comprising a computer program as above and a computer readable means on which the computer program is stored.

The object is according to a fifth aspect of the invention achieved by an antenna apparatus for calibration of an antenna array. The antenna apparatus comprises two or more transceiver chains. Each transceiver chain comprises a receive chain and a transmit chain. One of the at least two transceiver chains comprises an antenna calibration control unit and a reference calibration antenna, wherein the antenna calibration control unit is arranged to switch the transceiver chain between a calibration mode and a operation mode.

Further features and advantages of the invention will become clear upon reading the following description and the accompanying drawings.

### BRIEF DESCRIPTION OF THE DRAWINGS

FIG. 1 illustrates an antenna calibration apparatus in accordance with an embodiment.

FIG. 2 is a flow chart over steps of the methods in accordance with the invention.

FIG. 3 illustrates an antenna calibration signal.

FIG. 4 illustrates an antenna pilot mapping.

FIG. 5 is flow chart over steps of a method in accordance with an embodiment.

FIG. 6 illustrates a processor device in accordance with an embodiment.

### DETAILED DESCRIPTION

In the following description, for purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail. Same reference numerals refer to same or similar elements throughout the description.

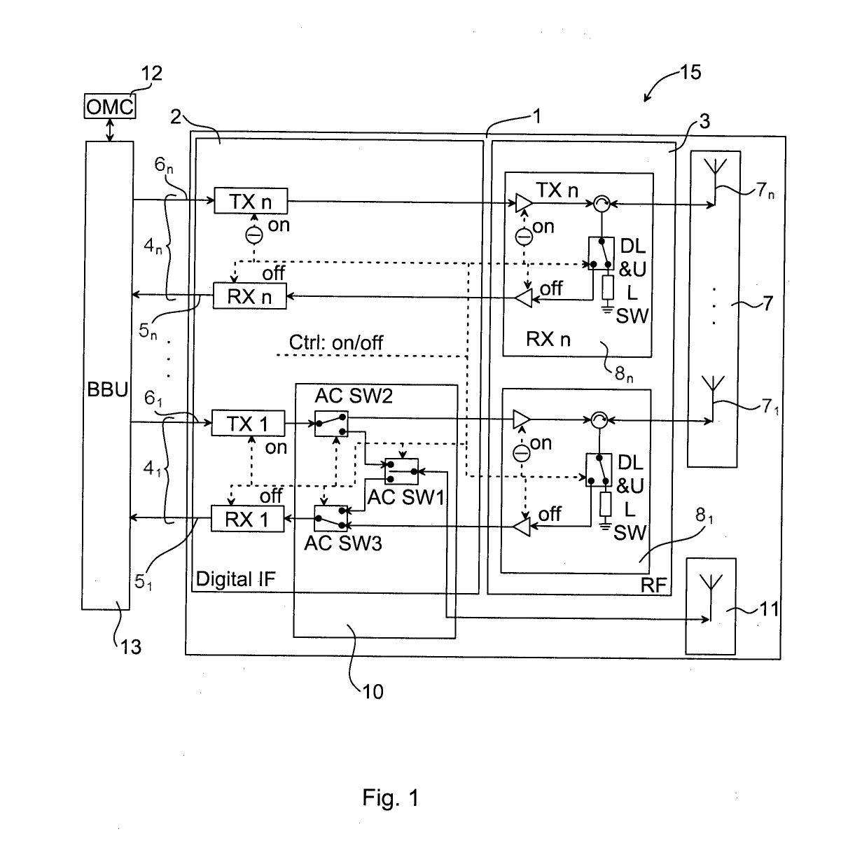

FIG. 1 illustrates an antenna array system 15 comprising an antenna apparatus 1 in accordance with an embodiment. The antenna apparatus 1 may for example comprise a remote radio unit (RRU) 1.

The antenna apparatus 1 comprises a transceiver part 2 and a power amplifier part 3 (or radio frequency part). The power amplifier part 3 comprises for each of a number of transceiver chains 4₁, . . . , 4ₙ transmit/receive switches 8₁, . . . , 8ₙ for switching a transmit chain 6ᵢ or a receive chain 5ᵢ to an antenna element 7ᵢ in common for them. The transceiver part 2 comprises conventional transceiver circuitry TX1, RX1; . . . ; TXn, RXn.

The antenna apparatus 1 comprises an antenna array 7. The antenna array 7 in turn comprises a number of antenna elements for receiving and transmitting radio frequency signals. Each transceiver chain comprises one antenna elements, i.e. the receive chain and the transmit chain of each transceiver chain have a common antenna element when receiving and transmitting signals, respectively.

The antenna apparatus 1 further comprises two or more transceiver chains 4₁, . . . , 4ₙ, and each transceiver chain 4₁, . . . , 4ₙ comprises a receive chain 5₁, . . . , 5ₙ and a transmit chain 6₁, . . . , 6ₙ. Each transceiver chain 4₁, . . . , 4ₙ is further connected to a respective one of the antenna elements 7₁, . . . , 7ₙ.

One of the transceiver chains 4₁, . . . , 4ₙ further comprises an antenna calibration control unit 10 and a reference calibration antenna 11. The antenna calibration control unit 10 is arranged to switch the transceiver chain 4₁ between a calibration mode and a operation mode. The antenna calibration control unit 10 is described further later in the description.

The antenna array system 15 further comprises a base band unit 13 performing base band signal processing. The base band unit 13 is connected to the antenna apparatus 1, and in particular to the transceiver part 2 thereof.

The antenna array system 15 further comprises an operation and maintenance center 12 connected to the base band unit 13. The operation and maintenance center 12 performs various functions, such as setting or reconfiguring antenna calibration commands.

Briefly, in accordance with an aspect of the invention, the antenna array calibration is divided into two steps, initial calibration and periodic calibration, the latter is also called real-time calibration. Initial calibration gets the compensation coefficient for transmitter and receiver direction; periodic calibration calibrates the transceiver and receiver path for a specified antenna without interruption of normal service in terms of the setting calibration period. As an example, two calibrations may be done during a guard period (GP) slot of a LTE system.

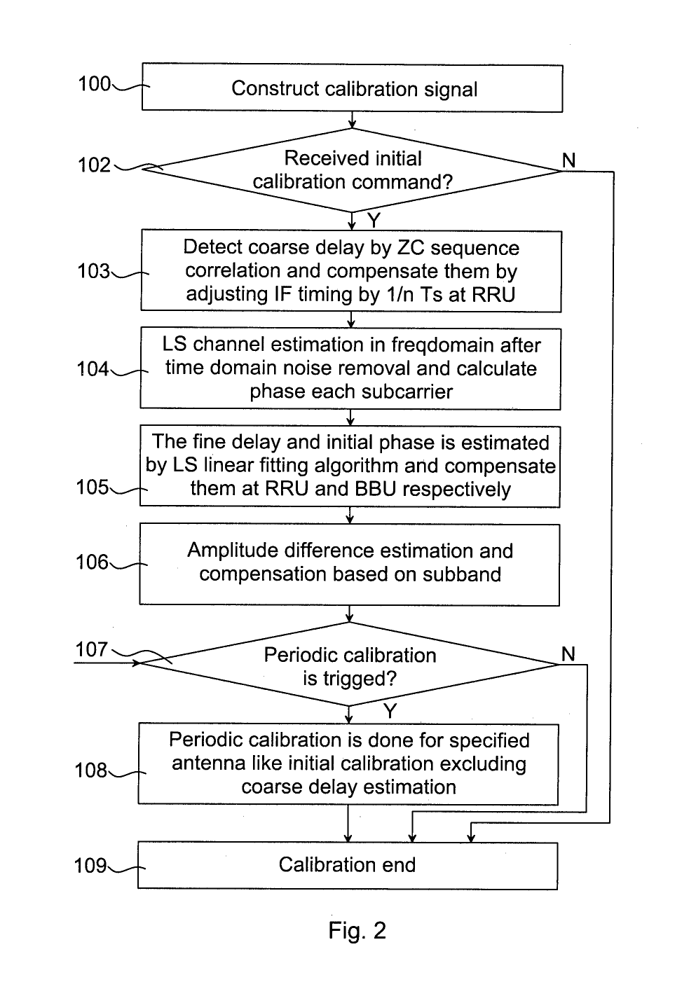

With reference now to FIG. 2, an embodiment of a method comprises the following steps:

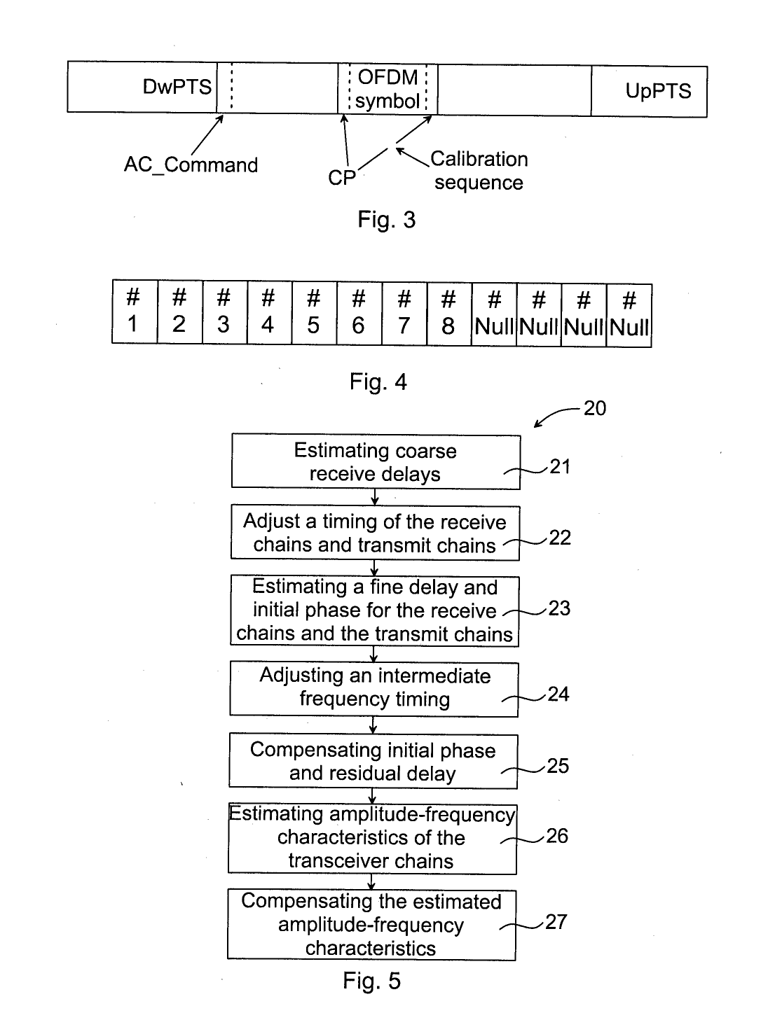

At box 100, a calibration signal is constructed. An example of such calibration signal is given with reference to FIG. 3.

At box 102, the antenna apparatus 1 switches its status to transmit calibration on or receive calibration on upon receiving a transmit or receive initial calibration command. Such command is issued after the antenna apparatus 1 and the base band unit 13 have preheated for a while. If no calibration command is received, the process ends (arrow denoted N), else the process flow continues to box 103 (arrow denoted Y).

At box 103, when transmit calibration is on, antenna path from one to n, in the following exemplified by eight, transmit the calibration pilot signal with the different u-root ZC sequences synchronously. The calibration antenna 11 will receive the eight orthogonal calibration signals. A coarse delay of the antenna paths (i.e. transceiver chains 40 is estimated jointly by searching the peak of the correlation power on local ZC sequence and receive signal. Intermediate frequency process elements will adjust its timing respectively to align with the max delay of the paths. When receive calibration is on. Calibration antenna transmits the calibration signal, the antenna path one to eight will receive this signal synchronously, the same procedure is done to estimate and compensate the receive delay difference.

At box 104, after coarse delay is compensated, the calibration signal is transmitted as in box 103 for receive calibration. For transmit calibration, the calibration pilot signals for 8 paths are interlaced with each other in frequency domain (refer also to FIG. 4). In other words, the i-th path will only send pilot elements at #i position every 12 subcarriers and #Null position denotes no signal mapped, which are used to noise estimation. The phase φₖ of the valid sub-carrier k is calculated after time-domain noise removal.

At box 105, the initial phase φᵢₙᵢ and delay Δt is estimated by the least square polynomial fit. The part of Δt is compensated as much as possible at the antenna apparatus 1 (RRU), such as ⅓ Ts or ⅙ Ts. The residual delay and φᵢₙᵢ will be compensated at base band unit signal.

At box 106, the whole bandwidth is divided into M sub-bands, such as M=100, 12 sub-carriers each sub-band for 20M system. One subcarrier is drawn every sub-band. After frequency-domain channel estimation based on pilot elements, noise is removed in time-domain and the amplitude calibration coefficient is gotten by time-domain discrete Fourier Transform (DFT) interpolation. The amplitude based on the whole bandwidth is compensated in frequency domain.

At box 107, when the periodic calibration command is received, and the initial calibration is not finished, the process flow ends (arrow indicated N), the initial calibration will have to be done firstly. If initial calibration done, then the process flow continues to box 108.

In box 108, the fine delay and initial phase is recalculated and compensated for the specified antenna as in box 105. For simplicity, only part of sub-carriers is involved.

In box 109, when initial calibration or periodic calibration is done, one antenna calibration process is finished and the process flow thus ends.

In the following the various steps are described more in detail.

### Coarse Delay Calibration and Compensation

When the delay is d·Tₛ, the received valid sub-carriers signal in frequency domain will be written as

r(k)=|Hₖ|e^{-jφ}^{ₖ}·xᵤ′(k)+nₖ

in which the k-th sub-carrier channel frequency response is Hₖ and white noise is nₖ.

The correlation power on the received valid sub-carriers signal and local ZC sequence is

PDPₐ(l)=|IFFT(xᵤ′(l)·r_{l,a}*)|²

The estimated delay is d_{est,a}=max(PDPₐ(l)), in which a represent antenna index. The delay difference is d_diffₐ=d_{est,a}−min(d_{est,a},aε{1, . . . , N}).

So, the intermediate frequency timing can be controlled in terms of d_diffₐ·Tₛ to keep timing alignment among antennas at antenna apparatus 1 side.

### Fine Delay and Initial Phase Calibration and Compensation

Assuming the residual delay Δₜ after coarse delay difference is compensated, the phase θₖ of valid sub-carrier k is

$${ϕ}_{k , a} = \{ \begin{matrix}angle ( {r}_{k , a} {x}_{u , k}^{′ *} ) , & 1 \leq k < M \\ angle ( {r}_{k , a} {x}_{u , k - M}^{′ *} ) , & N - M + 1 \leq k < N\end{matrix}$$

in which M=600,N=2048 for a 20M LTE system. K=0 is DC. a represents the antenna index of a specified antenna.

Assuming the initial phase is φ_{ini,a}, φ_{k,a} is also expressed as

$${ϕ}_{k , a} = \frac{2 π}{N} \times k \times Δ {t}_{a} / {T}_{s} + {ϕ}_{ini , a} + {n}_{k}$$

By the least square polynomial fit on the sub-carrier phase φ_{k,a}, we can get the estimation Δt_{est,a} and φᵢₙᵢ_{_{—}}_{est,a} as follows,

$$Δ {t}_{est , a} = \frac{L \cdot {\sum }_{k ∈ K} ( k \cdot {ϕ}_{k , a} ) - {\sum }_{k ∈ K} {ϕ}_{k , a} \cdot {\sum }_{k ∈ K} k}{L \cdot {\sum }_{k ∈ K} {k}^{2} - {( {\sum }_{k ∈ K} k )}^{2}} * \frac{N}{2 π}$$

$${ϕ}_{ini\_est , a} = \frac{{\sum }_{k ∈ K} ( k \cdot {ϕ}_{k , a} ) - {\sum }_{k ∈ K} k - {\sum }_{k ∈ K} {ϕ}_{k , a} \cdot {\sum }_{k ∈ K} {k}^{2}}{{( {\sum }_{k ∈ K} k )}^{2} - L \cdot {\sum }_{k ∈ K} {k}^{2}} ,$$

wherein K is a set of sub-carriers for reference and its length is Lsuch as K is one part of the total set of sub-carriers where φ_{k,a}ε(−π,+π) increases or decreases monotonically with the increasing sub-carrier index k.

As a particular example: for a 20 MHz TD-LTE system, with 30.72 MHz baseband oversampling rate, 2048 points FFT, k are the values [2:1:600] and [2040-600+1:1:2048], amounting to 1200 subcarriers. However, it is typically enough that only part of the 1200 subcarriers are used for estimating the delay and initial phase giving less complexity. Thus, L is a value less than 1200, e.g. 400, K is the set from which subcarriers are taken for estimating the delay and initial phase as reference.

Assuming the intermediate frequency sampling rate is M·Tₛ, for example M=6, the floor (the delay rounded down to) |Δt_{est,a}·M will be adjusted by intermediate frequency timing. The remaining delay Δt_{res,a}, which is defined by Δt_{res,a}=(Δt_{est,a}−floor(Δt_{est,a}·M)/M)Tₛ, and φᵢₙᵢ_{_{—}}_{est,a} is compensated by

$${Δϕ}_{k , a} = \frac{2 π}{N} \times k \times Δ {t}_{res , a} / {T}_{s} + {ϕ}_{ini , est , a}$$

on the sub-carrier k, respectively.

### Amplitude Calibration and Compensation

The received signal rₐ(t) is transformed into frequency domain and a valid sub-carriers rₐ(k) are drawn. For example, 12 subcarriers are called one sub-band. One sub-carrier for every sub-band is drawn to do least square (LS) channel estimation Hₐ(k) in frequency domain for the specified antenna a. For example, for a 20 MHz bandwidth and 8 antennas system,

$${H}_{a} ( k ) = \frac{{r}_{a} ( k )}{{x}_{u}^{′} ( k )} , \\ k = a , a + 12 , a + 24 , … , a + 12 * 99 ;$$

$$a = 1 , 2 , … 8$$

We can get Antenna #a mean power P_{average,a} and noise power P_{noise,a} by

$${P}_{average , a} = mean ( {\sum }_{k = valid subcarriers} {H}_{a} ( k ) * {{H}_{a} ( k )}^{H} )$$

$${P}_{noise , a} = mean ( {\sum }_{k = null subcarriers} {H}_{a} ( k ) * {{H}_{a} ( k )}^{H} )$$

Transforming Hₐ(k) to time-domain hₐ(n), we can get hₐ′(n) after noise removal,

hₐ(n)=IDFT(Hₐ(k))

hₐ′(n)=hₐ(n), when hₐ(n)>T_{threshold}*Pₙₒᵢₛₑ

Here, T_{threshold} is the threshold for valid signal selection from the received signal, which is gotten by offline simulation, for example, T_{threshold}=3.

Now calculating amplitude compensation coefficient A_{comp,a}′ basing on time-domain:

A_{comp,a}′=hₐ′(n)/\sqrt{P_{average,a}}

Finally, we can get the whole bandwidth amplitude compensation coefficient A_{comp,a}(k) by DFT interpolation,

A_{comp,a}(k)=DFT([A_{comp,a}′,zeros(1,1200−sizeof(A_{comp,a}′))],k=1, 2, . . . , 1200

The BBU signal will be amplified A_{comp,a} in order to remove transceiver power difference.

FIG. 3 illustrates an antenna calibration signal. One calibration signal is constructed offline. The u-th root ZC sequence is defined by

$${x}_{u} ( n ) = {e}^{- j \frac{π un ( n + 1 )}{{N}_{zc}}} ,$$

0≦n≦N_{zc}−1. The frequency domain ZC sequence will be made by xᵤ′(k)=DFT(xᵤ(n)), k=0, . . . , N_{zc}−1.

Mapping xᵤ′(k) to one OFDM symbol:

x_{c}(k)=[0,xᵤ′(1, . . . , xᵤ′(N₁),0₁, . . . , 0_{N}_{₂}xᵤ′(N₁+1), . . . , xᵤ′(N_{ZC})]

After addition of pre-CP (Cyclic Prefix) and post-CP, the transmitted signal s_{c}(n) in time domain is

s_{c}(n)=[S_{OFDM}(N_{FFT}−N_{CP}+1, . . . , N_{FFT})S_{OFDM}(1, . . . , N_{CP})]

in which S_{OFDM}(n)=FFT(x_{c}(k)). E.g, CP length Ncp=256, Nzc=839.

FIG. 4 illustrates an antenna pilot mapping. An i-th transceiver path will only send pilot elements at #i position every 12 subcarriers. #Null position denotes no signal being mapped. These #Null position are used for noise estimation. The phase φₖ of the valid sub-carrier k is calculated after time-domain noise removal. The initial phase φᵢₙᵢ and delay Δt is estimated by the least square polynomial fit. The part of Δt is compensated as much as posible at RRU, such as ⅓ Ts or ⅙ Ts. The residual delay and φᵢₙᵢ will be compensated at BBU signal.

FIG. 5 is flow chart over steps of a method 20 in accordance with an embodiment.

The method 20 is performed in an antenna array system 15 as described for calibration of the antenna apparatus 1. The antenna apparatus 1 comprises an antenna array 7 and two or more transceiver chains 4₁, . . . , 4ₙ, each transceiver chain 4₁, . . . , 4ₙ comprising a receive chain 5₁, . . . , 5ₙ, a transmit chain 6₁, . . . , 6ₙ and an antenna element 7₁, . . . , 7ₙ). One of the transceiver chains 4₁ further comprises an antenna calibration control unit 10 and a reference calibration antenna 11. The antenna calibration control unit 10 is arranged to switch the transceiver chain 4₁ between a calibration mode and a operation mode.

The method 20 comprises estimating 21 coarse receive delays for the receive chains 5₁, . . . , 5ₙ and coarse transmit delays for the transmit chains 6₁, . . . , 6ₙ.

The method 20 further comprises adjusting 22 a timing of the receive chains 5₁, . . . , 5ₙ based on the estimated coarse receive delays so that the receive chains 5₁, . . . , 5ₙ align with the maximum coarse receive delay difference and adjusting a timing of the transmit chains 6₁, . . . , 6ₙ based on the estimated coarse transmit delays so that the transmit chains 6₁, . . . , 6ₙ align with the maximum coarse transmit delay difference.

The method 20 further comprises estimating 23 a fine delay and initial phase for the receive chains 5₁, . . . , 5ₙ and the transmit chains 6₁, . . . , 6ₙ based on their phase-frequency characteristics.

The method 20 further comprises adjusting 24 an intermediate frequency timing of the antenna apparatus 1 based on the estimated fine delay.

The method 20 further comprises compensating 25 initial phase and residual delay at base band frequency-domain signal.

The method 20 further comprises estimating 26 amplitude-frequency characteristics of the transceiver chains 4₁, . . . , 4ₙ.

The method 20 further comprises compensating 27 the estimated amplitude-frequency characteristics at base band frequency-domain signal.

In an embodiment, the estimating 21 the coarse receive delay for the receive chains 5₁, . . . , 5ₙ may comprise:
switching the receive chain 5₁ of one of the two or more transceiver chains 4₁ into a receive calibration mode,
transmitting, by the reference calibration antenna 11, a calibration pilot signal,
receiving synchronously, by the receive chains 5₁, . . . , 5ₙ, the calibration pilot signal transmitted from the reference calibration antenna 11,
estimating 21 the coarse receive delay for all receive chains 5₁, . . . , 5ₙ of the transceiver chains 4₁, . . . , 4ₙ based on the received calibration pilot signal.

In an embodiment, the estimating the coarse transmit delay for the transmit chains 6₁, . . . , 6ₙ may comprise:
switching, by means of the antenna calibraion control unit 10, the transmit chain 6₁, . . . , 6ₙ of one of the two or more transceiver chains 4₁, . . . , 4ₙ into a transmit calibration mode, transmitting, by all transmit chains 6₁, . . . , 6ₙ a respective calibration pilot signal, the calibration pilot signals being orthogonal,
receiving, by the reference calibration antenna 11, the calibration pilot signals transmitted from the transmit chains 6₁, . . . , 6ₙ and
estimating 21 the coarse transmit delay for all transmit chains 6₁, . . . , 6ₙ of the transceiver chains 4₁, . . . , 4ₙ based on the received calibration pilot signals.

In an embodiment, the coarse receive delay and the coarse transmit delay may be determined by detecting a peak of the correlation power on local ZC sequence and the received calibration signals, for a coarse delay d·Tₛ and for the received calibration pilot signals r(k)=|Hₖ|e^{-jφ}^{ₖ}·xᵤ′(k)+nₖ,w in frequency domain, wherein the k-th sub-carrier channel frequency response is Hₖ and white noise is nₖ, wherein the correlation power is

PDPₐ(l)=|FFT(xᵤ′(l)·r_{l,a}*)|²,

, wherein the estimated coarse receive delay difference and the estimated coarse transmit delay difference is d_{est,a}=max(PDPₐ(l)), in which a represent antenna index, and the delay difference is set to d_diffₐ=min(d_{est,a}, aε{1, . . . , N}).

That is, the coarse receive delays for each receive chain is estimated. A receive delay difference is then the largest difference between two receive delays. The receive chains are adjusted so as to align with this maximum receive delay difference.

Correspondingly, the coarse transmit delays for each transmit chain is estimated. A transmit delay difference is then the largest difference between two transmit delays. The transmit chains are adjusted so as to align with this maximum transmit delay difference.

In an embodiment, the coarse delays (coarse receive delay and coarse transmit delay) may be estimated by correlation on the receive signal and local ZC sequence, which multiplex DSP's (Digital Signal Processor's) co-processor without BBU DSP load. That is, the cross correlation of two vectors is equivalent to Discrete Fourier Transform (DFT) on the frequency-domain dot-multiplication of two vectors, and since, in general, a DSP processor is configured with a DFT co-processor, the DFT operation does not consume DSP resource gain. All transceiver chains' coarse delays (transmit chains and receive chains, respectively) are estimated jointly by cycle-shift ZC sequence. The antennas amplitude calibration is easily done by DFT interpolation after time-domain noise removal.

In an embodiment, the adjusting 22 of a timing of the transceiver chains 4₁, . . . , 4ₙ based on the estimated coarse receive delays and the estimated coarse transmit delays, may be performed in an intermediate frequency part 2 of the antenna apparatus 1, thereby adjusting its timing respectively to align with the maximum delays of the transceiver chains 4₁, . . . 4ₙ.

In an embodiment, the estimating 23 of the fine delay and initial phase for the receive chains 5₁, . . . , 5ₙ may comprise:
switching the receive chain 5₁ of one of the two or more transceiver chains 4₁ into a receive calibration mode,
transmitting, by the reference calibration antenna 11, a calibration pilot signal,
receiving synchronously, by the receive chains 5₁, . . . , 5ₙ, the calibration pilot signal transmitted from the reference calibration antenna 11,
estimating 23 a fine delay and initial phase for all receive chains 5₁, . . . , 5ₙ of the transceiver chains 4₁, . . . , 4ₙ simultaneously based on their phase-frequency characteristics.

The phase of the sub-carrier k increases or decreases linearly, which is shown with increasing sub-carrier index k under any specified delay. The fine delay and initial phase of the transceiver chains can be estimated by such phase-frequency characteristics (phase vs. sub-carrier).

In an embodiment, the estimating 23 of fine delay and initial phase for the transmit chains 6₁, . . . , 6ₙ comprises:
switching, by means of the antenna calibration control unit 10, the transmit chain 6₁, . . . , 6ₙ of one of the two or more transceiver chains 4₁, . . . , 4ₙ into a transmit calibration mode,
transmitting, by the transmit chains 6₁, . . . , 6ₙ a calibration pilot signal on a respective specified sub-carrier,
receiving, by the reference calibration antenna 11, calibration pilot signals transmitted from the transmit chains 6₁, . . . , 6ₙ, and
estimating the fine delay and initial phase for the transmit chains 6₁, . . . , 6ₙ based on their phase-frequency characteristics.

In an embodiment, the estimating 23 the fine delay and initial phase for the receive chains 5₁, . . . , 5ₙ or the transmit chains 6₁, . . . , 6ₙ comprises, for a residual delay Δₜ after adjusting the estimated coarse receive delay difference and estimated coarse transmit delay difference:
determining a phase θₖ of sub-carrier k by:

$${ϕ}_{k , a} = \{ \begin{matrix}angle ( {r}_{k , a} {x}_{u , k}^{′ *} ) , & 1 \leq k < M \\ angle ( {r}_{k , a} {x}_{u , k - M}^{′ *} ) , & N - M + 1 \leq k < N\end{matrix}$$

wherein M is a number of sub-bands of the entire bandwidth N, a represents the antenna index, for an initial phase φ_{ini,a}, φ_{k,a} wherein

$${ϕ}_{k , a} = \frac{2 π}{N} \times k \times Δ {t}_{a} / {T}_{s} + {ϕ}_{ini , a} + {n}_{k}$$

estimating fine delay Δt_{est,a} by least square polynomial linear fit criterion on the sub-carrier phase φ_{k,a} and initial phase φᵢₙᵢ_{_{—}}_{est,a} in accordance with:

$$Δ {t}_{est , a} = \frac{L \cdot {\sum }_{k ∈ K} ( k \cdot {ϕ}_{k , a} ) - {\sum }_{k ∈ K} {ϕ}_{k , a} \cdot {\sum }_{k ∈ K} k}{L \cdot {\sum }_{k ∈ K} {k}^{2} - {( {\sum }_{k ∈ K} k )}^{2}} * \frac{N}{2 π}$$

$${ϕ}_{ini\_est , a} = \frac{{\sum }_{k ∈ K} ( k \cdot {ϕ}_{k , a} ) - {\sum }_{k ∈ K} k - {\sum }_{k ∈ K} {ϕ}_{k , a} \cdot {\sum }_{k ∈ K} {k}^{2}}{{( {\sum }_{k ∈ K} k )}^{2} - L \cdot {\sum }_{k ∈ K} {k}^{2}} ,$$

wherein K is a set of sub-carriers for reference and its length is L such as K is one part of the total set of sub-carriers where φ_{k,a}ε(−π,+π) increases or decreases monotonically with the increasing sub-carrier index k,
adjusting intermediate frequency timing by, for an intermediate frequency sampling rate of M·Tₛ, the delay rounded down to |Δt_{est,a}·M,
compensating the fine delay Δt_{res,a}, which is defined by Δt_{res,a}=(Δt_{est,a}−floor(Δt_{est,a}·M)/MTₛ, and the initial phase φᵢₙᵢ_{_{—}}_{est,a} by

$$Δ {ϕ}_{k , a} = \frac{2 π}{N} \times k \times Δ {t}_{res , a} / {T}_{s} + {ϕ}_{ini\_est , a}$$

on the sub-carrier k, respectively.

The fractional delay may thus be estimated by the least square polynomial fitting, which improves the calibration delay accuracy greatly. The antenna apparatus 1 adjusts its IF timing to assure all antennas transmitted air-interface signal and the received BBU signal are aligned as much as possible. BBU 13 may compensate the residual phase difference.

In an embodiment, an amplitude calibration based on the amplitude-frequency characteristics of the respective transceiver chains 4₁, . . . , 4ₙ comprises:
transforming a received signal rₐ(t) into frequency domain and extracting valid sub-carriers rₐ(k) of a specified antenna a, wherein system bandwidth is divided into N₁ sub-bands wherein each sub-band comprises M₁ sub-carriers and each sub-band has, among its M₁ sub-carriers, N sub-carriers mapped pilot signal from respective n transceiver chains 4₁, . . . , 4ₙ and wherein the remaining M₁−N sub-carriers are reserved for noise estimation,
performing a channel estimation Hₐ(k) in frequency domain for the specified antenna a based on a least square error criterion, in accordance with:
   for mean power P_{average,a} and noise power P_{noise,a}, for antenna a,

$${P}_{average , a} = mean ( {\sum }_{k = valid subcarriers} {H}_{a} ( k ) * {{H}_{a} ( k )}^{H} ) , \\ {P}_{noise , a} = mean ( {\sum }_{k = null subcarriers} {H}_{a} ( k ) * {{H}_{a} ( k )}^{H} ) ,$$

transforming Hₐ(k) into time-domain hₐ(n), thus obtaining hₐ(n) after noise removal,

hₐ(n)=IDFT(Hₐ(k))

hₐ′(n)=hₐ(n), when hₐ(n)>T_{threshold}*Pₙₒᵢₛₑ,

wherein T_{threshold} is a threshold for valid signal selection from the received signal,
calculating amplitude compensation coefficient A_{comp,a}′ in accordance with

A_{comp,a}′=hₐ′(n)/\sqrt{P_{average,a}}
performing a Discrete Fourier Transform, DFT, equivalent to time-domain interpolation, for obtaining an amplitude compensation coefficient A_{comp,a}(k) for the system bandwidth as:

A_{comp,a}(k)=DFT([A_{comp,a}′,zeros(1,1200−sizeof(A_{comp,a}′))],k=1, 2, . . . , 1200

In a variation of the above embodiment, a base band signal is amplified by A_{comp,a} for removing transceiver chain 6₁, . . . , 6ₙ power difference.

In an embodiment, the method 20 comprises receiving a periodic calibration command and recalculating the fine delay and the initial phase and re-compensating therefor for any specified antenna 7₁, . . . , 7ₙ.

In an embodiment, the calibration pilot signal is constructed by inserting a pre-cyclic prefix and a post-cyclic prefix for an OFDM symbol, the calibration pilot signal thus being transmitted in a guard period slot. Transmit and receive calibration may be finished in one half-frame, respectively.

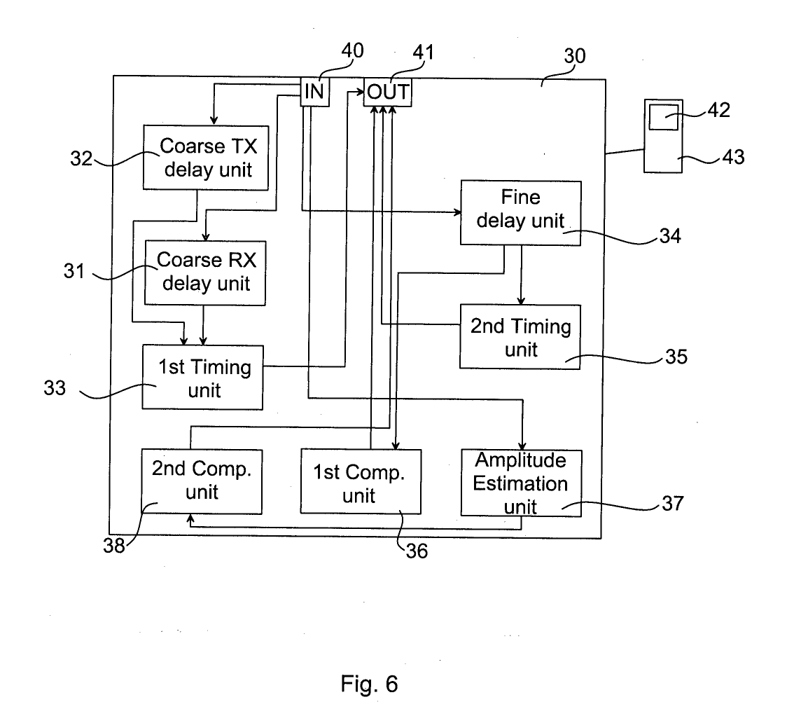

FIG. 6 illustrates a processing device in accordance with an embodiment. The processing device 30 is arranged for use in calibration of the antenna apparatus 1 as described. The processing device 30 comprises an input device 40 and an output device 41. The processing device 30 is arranged to perform the methods and algorithms as described earlier.

In particular, the processing device 30 is arranged to: estimate, by means of a coarse receive delay unit 31 and a coarse transmit delay unit 32, a coarse receive delays for the receive chains 5₁, . . . , 5ₙ and coarse transmit delays for the transmit chains 6₁, . . . , 6ₙ, respectively. The coarse receive delay unit 31 and a coarse transmit delay unit 32 may comprise circuitry for performing dot-multiplication, FFT (Fast Fourier transform) and a peak search.

The processing device 30 is further arranged to: adjust, by a first timing unit 33, a timing of the receive chains 5₁, . . . , 5ₙ based on the estimated coarse receive delays so that the receive chains 5₁, . . . , 5ₙ) align with the maximum coarse receive delay difference and adjusting a timing of the transmit chains 6₁, . . . , 6ₙ based on the estimated coarse transmit delays so that the transmit chains 6₁, . . . , 6ₙ align with the maximum coarse transmit delay difference. The first timing unit 33 may comprise circuitry for performing maximum delay calculation, a delay difference calculation relative to the maximum delay and IF timing compensation.

The processing device 30 is further arranged to: estimate, by a fine delay and initial phase unit 34, a fine delay and initial phase for the receive chains (5₁, . . . , 5ₙ) and the transmit chains (6₁, . . . , 6ₙ) based on their phase-frequency characteristics. The fine delay and initial phase unit 34 may comprise circuitry for performing a sub-carrier phase calculation, a fine delay estimation and a initial phase estimation.

The processing device 30 is further arranged to: adjust, by a second timing unit 35, an intermediate frequency timing of the antenna apparatus 1 based on the estimated fine delay. The second timing unit 35 may comprise circuitry for performing a delay difference calculation and IF timing compensation.

The processing device 30 is further arranged to: compensate, by a first compensating unit 36, initial phase and residual delay at base band frequency-domain signal. The first compensating unit 36 may comprise a circuitry for performing a residual delay calculation, sub-carrier phase shift compensation calculation.

The processing device 30 is further arranged to: estimate, by an estimation unit 37, amplitude-frequency characteristics of the transceiver chains 4₁, . . . , 4ₙ. The estimation unit 37 may comprise a FFT module, a zero padding unit and a vector multiplication unit or other circuitry for performing the operations.

The processing device 30 is further arranged to: compensate, by a second compensating unit 38, the estimated amplitude-frequency characteristics at base band frequency-domain signal. The second compensating unit 38 may comprise circuitry for performing a vector division and a vector multiplication.

From FIG. 6 and the description it is realized that the input device 40 provides inputs to coarse transmit delay unit 32, coarse receive delay unit 31, estimation unit 37 and fine delay and initial phase unit 34. The output device 41 receives data that is output from first timing unit 33, first compensating unit 36, second compensating unit 38, second timing unit 35. Further, the output from coarse transmit delay unit 32 and the output from coarse receive delay unit 31 are input to first timing unit 33; the output of estimation unit 37 is input to second compensating unit 38; the output of fine delay and initial phase unit 34 is input to second timing unit 35 and first compensating unit 36. It is noted that although illustrated as separate units by function, the actual implementation may differ from what is illustrated.

It is noted that the above functions and steps of the various units can be implemented in hardware, software, firmware or any combination thereof. For example, a timing unit may be implemented by software or by hardware components or a combination thereof. This is true for all the described units. As a particular example it can be mentioned that e.g. a coarse delay adjusting unit may be implemented by field-programmable gate array (FGPA) in the RRU (hardware).

With reference still to FIG. 6, the invention also encompasses a computer program 42 a processing device 30. The computer program 42 comprises computer program code which when run on the processing device 30, causes the processing device 30 to perform the methods as described.

In particular, the computer program 42 may be used in the processing device 30 for calibration of an antenna apparatus 1. As already described, the antenna apparatus 1 comprises an antenna array 7 and two or more transceiver chains 4₁, . . . , 4ₙ, each transceiver chain 4₁, . . . , 4ₙ comprising a receive chain 5₁, . . . , 5ₙ and a transmit chain 6₁, . . . , 6ₙ and an antenna element 7₁, . . . , 7ₙ. One transceiver chain 4₁ of the at least two transceiver chains 4₁, . . . , 4ₙ further comprises an antenna calibration control unit 10 and a reference calibration antenna 11. The antenna calibration control unit 10 is arranged to switch the transceiver chain 4₁ between a calibration mode and a operation mode. The computer program 42 comprises computer program code, which, when run on the processing device 30, causes the processing device 30 to perform the steps of: estimating coarse receive delays for the receive chains 5₁, . . . , 5ₙ and coarse transmit delays for the transmit chains 6₁, . . . , 6ₙ; adjusting a timing of the receive chains 5₁, . . . , 5ₙ based on the estimated coarse receive delays so that the receive chains 5₁, . . . 5ₙ align with the maximum coarse receive delay difference and adjusting a timing of the transmit chains 6₁, . . . , 6ₙ based on the estimated coarse transmit delays so that the transmit chains 6₁, . . . , 6ₙ align with the maximum coarse transmit delay difference; estimating a fine delay and initial phase for the receive chains 5₁, . . . 5ₙ and the transmit chains 6₁, . . . , 6ₙ based on their phase-frequency characteristics; adjusting 24 an intermediate frequency timing of the antenna apparatus 1 based on the estimated fine delay; compensating initial phase and residual delay at base band frequency-domain signal; estimating amplitude-frequency characteristics of the transceiver chains 4₁, . . . , 4ₙ; and compensating the estimated amplitude-frequency characteristics at base band frequency-domain signal.

A computer program product 43 is also provided comprising the computer program 42 and computer readable means on which the computer program 42 is stored. The computer program product 43 may be any combination of read and write memory (RAM) or read only memory (ROM). The computer program product 43 may also comprise persistent storage, which, for example can be any single one or combination of magnetic memory, optical memory, or solid state memory.

With reference again to FIG. 1, the invention also encompasses the antenna apparatus 1 as described for calibration of an antenna array 7. The antenna apparatus 1 comprises two or more transceiver chains 4₁, . . . , 4ₙ each transceiver chain 4₁, . . . , 4ₙ comprising a receive chain 5₁, . . . , 5ₙ and a transmit chain 6₁, . . . , 6ₙ. One of the at least two transceiver chains 4₁, . . . , 4ₙ comprises an antenna calibration control unit 10 and a reference calibration antenna 11. The antenna calibration control unit 10 is arranged to switch the transceiver chain 4₁ between a calibration mode and an operation mode.

In order to switch the receive chain 5₁ and the transmit chain 6₁ of the transceiver chain 4₁ between the different modes, the antenna calibration control unit 10 may comprise a number of switches. In an embodiment a first switch SW1, a second switch SW2 and a third switch SW3 are arranged to switch the transceiver chain 4₁ between a operation mode, a transmit calibration mode and a receive calibration mode. The switches SW1, SW2, SW3 may each take one of two positions, i.e. they are switchable between these two positions.

The first switch SW1 is arranged to connect the transmit chain 6₁ and the receive chain 5₁ of the transceiver chain 4₁ to the reference calibration antenna 11. That is, in a first position of the first switch SW1, the transmit chain 6₁ is connected to the reference calibration antenna 11, and when the first switch SW1 is in a second position, the receive chain 5₁ is connected to the reference calibration antenna 11.

The second switch SW2 is arranged to switch the transmit chain 6₁ between a transmit calibration mode and an operation mode. When the second switch SW2 is in a first position, the transceiver chain 6₁ is in its normal operation mode. When the second switch SW2 is in its second position, the transceiver chain 6₁ is in a transmit calibration mode.

The third switch SW3 is arranged to switch the receive chain 5₁ between a receive calibration mode and an operation mode. When the third switch SW3 is in a first position, the receive chain 5₁ is in its normal operation mode. When the third switch SW3 is in its second position, the receive chain 5₁ is in a receive calibration mode.

The transmit chain 6₁ may be by connected to the antenna element 7₁ of the of the antenna array 7 (of the transceiver chain 4₂) by means of the second switch SW2 and the first switch SW1. The transmit chain 6₁ is then in operation mode. The transmit chain 6₁ may be by connected to the reference calibration antenna 11 by means of the second switch SW2 and the first switch SW1. The transmit chain 6₁ is then in the transmit calibration mode.

The receive chain 5₁ may be by connected to the antenna element 7₁ of the of the antenna array 7 (of the transceiver chain 4₁) by means of the third switch SW3 and the first switch SW1. The receive chain 5₁ is then in operation mode. The receive chain 5₁ may be by connected to the reference calibration antenna 11 by means of the third switch SW3 and the first switch SW1. The receive chain 5₁ is then in the transmit calibration mode.

Below some advantages and features are reiterated:

The coarse delay is estimated by correlation on the receive signal and local ZC sequence, which multiplex DSP's coprocessor without BBU DSP load. All antenna coarse delay is estimated jointly by cycle-shift ZC sequence. The antennas amplitude calibration is easily done by DFT interpolation after time-domain noise removal.

The fractional delay is estimated by the least square polynomial fitting, which improve the calibration delay accuracy greatly. RRU adjusts its IF timing to assure all antennas transmitted air-interface signal and the received BBU signal aligned as much as possible. BBU compensates the residual phase difference.

The methods support sub-bands calibration for a wideband system simultaneously. And the group delays for all sub-bands could be detected jointly.

The methods are implemented with less DSP load and better calibration performance. Transmit and receive calibrations are finished in one half-frame, respectively.

1. A method (20) in an antenna array system (15) for calibration of an antenna apparatus (1), the antenna apparatus (1) comprising an antenna array (7) and two or more transceiver chains (4₁, . . . , 4ₙ), each transceiver chain (4₁, . . . , 4ₙ) comprising a receive chain (5₁, . . . , 5ₙ) and a transmit chain (6₁, . . . , 6ₙ) and an antenna element (7₁, . . . , 7ₙ), wherein one transceiver chain (4₁) of the at least two transceiver chains (4₁, . . . , 4ₙ) further comprises an antenna calibration control unit (10) and a reference calibration antenna (11), wherein the antenna calibration control unit (10) is arranged to switch the transceiver chain (4₁) between a calibration mode and a operation mode, wherein the method (20) comprises:
estimating (21) coarse receive delays for the receive chains (5₁, . . . , 5ₙ) and coarse transmit delays for the transmit chains (6₁, . . . , 6ₙ),
adjusting (22) a timing of the receive chains (5₁, . . . , 5ₙ) based on the estimated coarse receive delays so that the receive chains (5₁, . . . , 5ₙ) align with the maximum coarse receive delay difference and adjusting a timing of the transmit chains (6₁, . . . , 6ₙ) based on the estimated coarse transmit delays so that the transmit chains (6₁, . . . , 6ₙ) align with the maximum coarse transmit delay difference,
estimating (23) a fine delay and initial phase for the receive chains (5₁, . . . , 5ₙ) and the transmit chains (6₁, . . . , 6ₙ) based on their phase-frequency characteristics,
adjusting (24) an intermediate frequency timing of the antenna apparatus (1) based on the estimated fine delay,
compensating (25) initial phase and residual delay at base band frequency-domain signal,
estimating (26) amplitude-frequency characteristics of the transceiver chains (4₁, . . . , 4ₙ), and
compensating (27) the estimated amplitude-frequency characteristics at base band frequency-domain signal.

2. The method (20) as claimed in claim 1, wherein the estimating the coarse (21) receive delay for the receive chains (5₁, . . . 5ₙ) comprises:
switching the receive chain (5₁) of one of the two or more transceiver chains (4₁) into a receive calibration mode,
transmitting, by the reference calibration antenna (11), calibration pilot signal,
receiving synchronously, by the receive chains (5₁, . . . , 5ₙ), the calibration pilot signal transmitted from the reference calibration antenna (11),
estimating (21) the coarse receive delay for all receive chains (5₁, . . . , 5ₙ) of the transceiver chains (4₁, . . . , 4ₙ) based on the received calibration pilot signal.

3. The method (20) as claimed in claim 1 or 2, wherein the estimating the coarse transmit delay for the transmit chains (6₁, . . . , 6ₙ) comprises:
switching, by means of the antenna calibration control unit (10), the transmit chain (6₁, . . . , 6ₙ) of one of the two or more transceiver chains (4₁, . . . , 4ₙ) into a transmit calibration mode,
transmitting, by all transmit chains (6₁, . . . , 6ₙ), a respective calibration pilot signal, the calibration pilot signals being orthogonal,
receiving, by the reference calibration antenna (11), the calibration pilot signals transmitted from the transmit chains (6₁, . . . , 6ₙ), and
estimating (21) the coarse transmit delay for all transmit chains (6₁, . . . , 6ₙ) of the transceiver chains (4₁, . . . , 4ₙ) based on the received calibration pilot signals.

4. The method (20) as claimed in claim 2 or 3, wherein the coarse receive delay and the coarse transmit delay is determined by detecting a peak of the correlation power on local ZC sequence and the received calibration signals, for a coarse delay d·Tₛ and for the received calibration pilot signals r(k)=|Hₖ|e^{-jφ}^{ₖ}·xᵤ′(k)+nₖ,w in frequency domain, wherein the k-th sub-carrier channel frequency response is Hₖ and white noise is nₖ, wherein the correlation power is
PDPₐ(l)=|IFFT(xᵤ′(l)·r_{l,a}*)|²,
, wherein the estimated coarse receive delay difference and the estimated coarse transmit delay difference is d_{est,a}=max(PDPₐ(l)), in which a represent antenna index, and the delay difference is set to d_diffₐ=d_{est,a}−min(d_{est,a},aε{1, . . . , N}).

5. The method (20) as claimed in any of claims 1-4, wherein the adjusting (22) a timing of the transceiver chains (4₁, . . . , 4ₙ) based on the estimated coarse receive delays and the estimated coarse transmit delays, is performed in an intermediate frequency part (2) of the antenna apparatus (1), thereby adjusting its timing respectively to align with the maximum delay of the transceiver chains (4₁, . . . , 4ₙ).

6. The method (20) as claimed in any of the preceding claims, wherein estimating (23) the fine delay and initial phase for the receive chains (5₁, . . . , 5ₙ) comprises:
switching the receive chain (5₁) of one of the two or more transceiver chains (4₁) into a receive calibration mode,
transmitting, by the reference calibration antenna (11), a calibration pilot signal,
receiving synchronously, by the receive chains (5₁, . . . , 5ₙ), the calibration pilot signal transmitted from the reference calibration antenna (11),
estimating (23) a fine delay and initial phase for all receive chains (5₁, . . . , 5ₙ) of the transceiver chains (4₁, . . . , 4ₙ) simultaneously based on their phase-frequency characteristics.

7. The method (20) as claimed in any of the preceding claims, wherein the estimating (23) of fine delay and initial phase for the transmit chains (6₁, . . . , 6ₙ) comprises:
switching, by means of the antenna calibration control unit (10), the transmit chain (6₁, . . . , 6ₙ) of one of the two or more transceiver chains (4₁, . . . , 4ₙ) into a transmit calibration mode,
transmitting, by the transmit chains (6₁, . . . , 6ₙ), a calibration pilot signal on a respective specified sub-carrier,
receiving, by the reference calibration antenna (11), calibration pilot signals transmitted from the transmit chains (6₁, . . . , 6ₙ), and
estimating the fine delay and initial phase for the transmit chains (6₁, . . . , 6ₙ) based on their phase-frequency characteristics.

8. The method (20) as claimed in claim 6 or 7, wherein the estimating (23) the fine delay and initial phase for the receive chains (5₁, . . . , 5ₙ) or the transmit chains (6₁, . . . , 6ₙ) comprises, for a residual delay Δₜ after adjusting the estimated coarse receive delay difference and estimated coarse transmit delay difference:
determining a phase θₖ of sub-carrier k by:
$${ϕ}_{k , a} = \{ \begin{matrix}angle ( {r}_{k , a} {x}_{u , k}^{′ *} ) , & 1 \leq k < M \\ angle ( {r}_{k , a} {x}_{u , k - M}^{′ *} ) , & N - M + 1 \leq k < N\end{matrix}$$
wherein M is a number of sub-bands of the entire bandwidth N, a represents the antenna index, for an initial phase φ_{ini,a}, φ_{k,a} wherein
$${ϕ}_{k , a} = \frac{2 π}{N} \times k \times Δ {t}_{a} / {T}_{s} + {ϕ}_{ini , a} + {n}_{k}$$
estimating fine delay Δt_{est,a} by least square polynomial linear fit criterion on the sub-carrier phase φ_{k,a}, and initial phase φᵢₙᵢ_{_{—}}_{est,a} in accordance with:
$$Δ {t}_{est , a} = \frac{L \cdot {\sum }_{k ∈ K} ( k \cdot {ϕ}_{k , a} ) - {\sum }_{k ∈ K} {ϕ}_{k , a} \cdot {\sum }_{k ∈ K} k}{L \cdot {\sum }_{k ∈ K} {k}^{2} - {( {\sum }_{k ∈ K} k )}^{2}} * \frac{N}{2 π}$$
$${ϕ}_{ini\_est , a} = \frac{{\sum }_{k ∈ K} ( k \cdot {ϕ}_{k , a} ) - {\sum }_{k ∈ K} k - {\sum }_{k ∈ K} {ϕ}_{k , a} \cdot {\sum }_{k ∈ K} {k}^{2}}{{( {\sum }_{k ∈ K} k )}^{2} - L \cdot {\sum }_{k ∈ K} {k}^{2}} ,$$
wherein K is a set of sub-carriers for reference and its length is L such as K is one part of the total set of sub-carriers where φ_{k,a}ε(−π,+π) increases or decreases monotonically with the increasing sub-carrier index k,
adjusting intermediate frequency timing by, for an intermediate frequency sampling rate of M·Tₛ, the delay rounded down to |Δt_{est,a}·M,
compensating the fine delay Δt_{res,a}, which is defined by Δt_{res,a}=(Δt_{est,a}−floor(Δt_{est,a}·M)/M)Tₛ, and the initial phase φᵢₙᵢ_{_{—}}_{est,a} by
$$Δ {ϕ}_{k , a} = \frac{2 π}{N} \times k \times Δ {t}_{res , a} / {T}_{s} + {ϕ}_{ini\_est , a}$$
on the sub-carrier k, respectively.

9. The method (20) as claimed in any of the preceding claims, wherein an amplitude calibration based on the amplitude-frequency characteristics of the respective transceiver chains (4₁, . . . , 4ₙ) comprises:
transforming a received signal rₐ(t) into frequency domain and extracting valid sub-carriers rₐ(k) of a specified antenna a, wherein system bandwidth is divided into N₁ sub-bands wherein each sub-band comprises M₁ sub-carriers and each sub-band has, among its M₁ sub-carriers, N sub-carriers mapped pilot signal from respective n transceiver chains (4₁, . . . 4ₙ) and wherein the remaining M₁−N sub-carriers are reserved for noise estimation,
performing a channel estimation Hₐ(k) in frequency domain for the specified antenna a based on a least square error criterion, in accordance with:
for mean power P_{average,a} and noise power P_{noise,a} for antenna a,
$${P}_{average , a} = mean ( {\sum }_{k = valid subcarriers} {H}_{a} ( k ) * {{H}_{a} ( k )}^{H} ) , \\ {P}_{noise , a} = mean ( {\sum }_{k = null subcarriers} {H}_{a} ( k ) * {{H}_{a} ( k )}^{H} ) ,$$
transforming Hₐ(k) into time-domain hₐ(n), thus obtaining hₐ(n) after noise removal,
hₐ(n)=IDFT(Hₐ(k))
hₐ′(n)=hₐ(n), when hₐ(n)>T_{threshold}*Pₙₒᵢₛₑ,
wherein T_{threshold} is a threshold for valid signal selection from the received signal,
calculating amplitude compensation coefficient A_{comp,a}′ in accordance with
A_{comp,a}′=hₐ′(n)/\sqrt{P_{average,a}}
performing a Discrete Fourier Transform, DFT, equivalent to time-domain interpolation, for obtaining an amplitude compensation coefficient A_{comp,a}(k) for the system bandwidth as:
A_{comp,a}(k)=DFT([A_{comp,a}′,zeros(1,1200−sizeof(A_{comp,a}′))],k=1, 2, . . . , 1200

10. The method (20) as claimed in claim 9, wherein a base band signal is amplified by A_{comp}, for removing transceiver chain (6₁, . . . , 6ₙ) power difference.

11. The method (20) as claimed in any of the preceding claims, comprising receiving a periodic calibration command and recalculating the fine delay and the initial phase and re-compensating therefor for any specified antenna (7₁, . . . , 7ₙ).

12. The method (20) as claimed in any of the preceding claims, wherein the calibration pilot signal is constructed by inserting a pre-cyclic prefix and a post-cyclic prefix for an OFDM symbol, the calibration pilot signal thus being transmitted in a guard period slot.

13. A processing device (30) for calibration of an antenna apparatus (1), the antenna apparatus (1) comprising an antenna array (7) and two or more transceiver chains (4₁, . . . , 4ₙ), each transceiver chain (4₁, . . . , 4ₙ) comprising a receive chain (5₁, . . . , 5ₙ) and a transmit chain (6₁, . . . , 6ₙ) and an antenna element (7₁, . . . , 7ₙ), wherein one transceiver chain (4₁) of the at least two transceiver chains (4₁, . . . , 4ₙ) further comprises an antenna calibration control unit (10) and a reference calibration antenna (11), wherein the antenna calibration control unit (10) is arranged to switch the transceiver chain (4₁) between a calibration mode and a operation mode, wherein the processing device (30) is arranged to:
estimate, by means of a coarse receive delay unit (31) and a coarse transmit delay unit (32), a coarse receive delays for the receive chains (5₁, . . . , 5ₙ) and coarse transmit delays for the transmit chains (6₁, . . . , 6ₙ), respectively,
adjust, by a first timing unit (33), a timing of the receive chains (5₁, . . . , 5ₙ) based on the estimated coarse receive delays so that the receive chains (5₁, . . . , 5ₙ) align with the maximum coarse receive delay difference and adjusting a timing of the transmit chains (6₁, . . . , 6ₙ) based on the estimated coarse transmit delays so that the transmit chains (6₁, . . . , 6ₙ) align with the maximum coarse transmit delay difference,
estimate, by a fine delay and initial phase unit (34), a fine delay and initial phase for the receive chains (5₁, . . . , 5ₙ) and the transmit chains (6₁, . . . , 6ₙ) based on their phase-frequency characteristics,
adjust, by a second timing unit (35), an intermediate frequency timing of the antenna apparatus (1) based on the estimated fine delay,
compensate, by a first compensating unit (36), initial phase and residual delay at base band frequency-domain signal,
estimate, by an estimation unit (37), amplitude-frequency characteristics of the transceiver chains (4₁, . . . , 4ₙ), and
compensate, by a second compensating unit (38), the estimated amplitude-frequency characteristics at base band frequency-domain signal.

14. A computer program (42) for a processing device (30) for calibration of an antenna apparatus (1), the antenna apparatus (1) comprising an antenna array (7) and two or more transceiver chains (4₁, . . . , 4ₙ), each transceiver chain (4₁, . . . , 4ₙ) comprising a receive chain (5₁, . . . , 5ₙ) and a transmit chain (6₁, . . . , 6ₙ) and an antenna element (7₁, . . . , 7ₙ), wherein one transceiver chain (4₁) of the at least two transceiver chains (4₁, . . . , 4ₙ) further comprises an antenna calibration control unit (10) and a reference calibration antenna (11), wherein the antenna calibration control unit (10) is arranged to switch the transceiver chain (40 between a calibration mode and a operation mode, the computer program (42) comprising computer program code, which, when run on the processing device (30), causes the processing device (30) to perform the steps of:
estimating coarse receive delays for the receive chains (5₁, . . . , 5ₙ) and coarse transmit delays for the transmit chains (6₁, . . . , 6ₙ),
adjusting a timing of the receive chains (5₁, . . . , 5ₙ) based on the estimated coarse receive delays so that the receive chains (5₁, . . . , 5ₙ) align with the maximum coarse receive delay difference and adjusting a timing of the transmit chains (6₁, . . . 6ₙ) based on the estimated coarse transmit delays so that the transmit chains (6₁, . . . , 6ₙ) align with the maximum coarse transmit delay difference,
estimating a fine delay and initial phase for the receive chains (5₁, . . . , 5ₙ) and the transmit chains (6₁, . . . , 6ₙ) based on their phase-frequency characteristics,
adjusting (24) an intermediate frequency timing of the antenna apparatus (1) based on the estimated fine delay,
compensating initial phase and residual delay at base band frequency-domain signal,
estimating amplitude-frequency characteristics of the transceiver chains (4₁, . . . , 4ₙ), and
compensating the estimated amplitude-frequency characteristics at base band frequency-domain signal.

15. A computer program product (43) comprising a computer program (42) as claimed in claim 14, and a computer readable means on which the computer program (42) is stored.

16. An antenna apparatus (1) for calibration of an antenna array (7), the antenna apparatus (1) comprising two or more transceiver chains (4₁, . . . , 4ₙ), each transceiver chain (4₁, . . . , 4ₙ) comprising a receive chain (5₁, . . . , 5ₙ) and a transmit chain (6₁, . . . , 6ₙ), and wherein one of the at least two transceiver chains (4₁, . . . , 4ₙ) comprises an antenna calibration control unit (10) and a reference calibration antenna (11), wherein the antenna calibration control unit (10) is arranged to switch the transceiver chain (4₁) between a calibration mode and a operation mode.

17. The antenna apparatus (1) as claimed in claim 16, wherein the antenna calibration control unit (10) comprises a first switch SW1, a second switch SW2 and a third switch SW3 arranged to switch the transceiver chain (4₁) between a operation mode, a transmit calibration mode and a receive calibration mode.

18. The antenna apparatus (1) as claimed in claim 17, wherein the first switch SW1 is arranged to connect the transmit chain (6₁) and the receive chain (5₁) of the transceiver chain (4₁) to the reference calibration antenna (11), the second switch SW2 is arranged to switch the transmit chain (6₁) between a transmit calibration mode and an operation mode, and the third switch SW3 is arranged to switch the receive chain (5₁) between a receive calibration mode and an operation mode.

19. The antenna apparatus (1) as claimed in claim 18, wherein the transmit chain (6₁) is, by means of the second switch SW2 and the first switch SW1, connected to an antenna element (7₁) of the antenna array (7) when in operation mode, and to the reference calibration antenna (11) when in the transmit calibration mode.

20. The antenna apparatus (1) as claimed in claim 18 or 19, wherein the receive chain (5₁) is, by means of the third switch SW3 and the first switch SW1, connected to an antenna element (7₁) of the antenna array (7) when in operation mode, and to the reference calibration antenna (11) when in the receive calibration mode.
